(19) United States
(12) Patent Application Publication
(10) Pub. No.: US 2011/0148922 A1
(43) Pub. Date: Jun. 23, 2011

(54) APPARATUS AND METHOD FOR MIXED REALITY CONTENT OPERATION BASED ON INDOOR AND OUTDOOR CONTEXT AWARENESS

(75) Inventors: Wook Ho SON, Daejeon (KR); Gun Lee, Daejeon (KR); Jin Sung Choi, Seongnam (KR); Il Kwon Jeong, Daejeon (KR)

(73) Assignee: Electronics and Telecommunications Research Institute, Daejeon (KR)

(21) Appl. No.: 12/895,794

(22) Filed: Sep. 30, 2010

(30) Foreign Application Priority Data
Dec. 21, 2009 (KR) 10-2009-0127714

(51) Int. Cl. G09G 5/00

(52) U.S. Cl. 345/633

(57) ABSTRACT

Provided are an apparatus and method for mixed reality content operation based on indoor and outdoor context awareness. The apparatus for mixed reality content operation includes a mixed reality visualization processing unit superposing at least one of a virtual object and a text on an actual image which is acquired through the camera to generate a mixed reality image; a context awareness processing unit receiving at least one of sensed data peripheral to the mobile device and a location and posture data of the camera to perceive a peripheral context of the mobile device on the basis of the received data; and a mixed reality application content driving unit adding a content in the mixed reality image to generate an application service image, the content being provided in a context linking type according to the peripheral context.

### CROSS-REFERENCE TO RELATED APPLICATIONS

This application claims priority under 35 U.S.C. §119 to Korean Patent Application No. 10-2009-0127714, filed on Dec. 21, 2009, in the Korean Intellectual Property Office, the disclosure of which is incorporated herein by reference in its entirety.

### TECHNICAL FIELD

The following disclosure relates to an apparatus and method for mixed reality content operation based on indoor and outdoor context awareness.

### BACKGROUND

A mobile application content apparatus based on indoor and outdoor context awareness provides an information which is acquired from a unique Radio Frequency Identification (RFID) tag attached to each exhibition item inside exhibition halls such as museums, or provides additional information with only image recognition information, in an indoor environment.

In an outdoor environment, the mobile application content apparatus uses only image recognition information as in an indoor environment. That is because information acquired from a sensor network cannot be used simultaneously with image recognition information. Therefore, a limited mobile application content is provided in an outdoor environment.

In addition, since the mobile application content apparatus uses only data that are stored in the database (DB ) of a Geographic Information System (GIS) for perceiving accurate geographical and natural features in an outdoor environment, it cannot accurately discriminate individual geographical and natural features, and cannot provide detailed building guidance information or way guidance information having no error.

### SUMMARY

In one general aspect, an apparatus for mixed reality content operation based on a mobile device mounting a camera includes: a mixed reality visualization processing unit superposing at least one of a virtual object and a text on an actual image which is acquired through the camera to generate a mixed reality image: a context awareness processing unit receiving at least one of sensed data peripheral to the mobile device and a location and posture data of the camera to perceive a peripheral context of the mobile device on the basis of the received data; and a mixed reality application content driving unit adding a content in the mixed reality image to generate an application service image, the content being provided in a context linking type according to the peripheral context.

In another general aspect, a method for mixed reality content operation based on a mobile device with a camera includes: receiving at least one of a peripheral data of the mobile device and a location and posture data of the camera; superposing at least one of a virtual object and a text on an actual image which is acquired through the camera to generate a mixed reality image; perceiving a peripheral context of the mobile device on the basis of the peripheral data and the location and posture data; and adding a content in a context linking type according to the peripheral context in the mixed reality image to generate an application service image.

Other features and aspects will be apparent from the following detailed description, the drawings, and the claims.

### BRIEF DESCRIPTION OF THE DRAWINGS

FIG. 1 is a block diagram illustrating an apparatus for mixed reality content operation according to an exemplary embodiment.

FIGS. 2 and 3 are diagrams illustrating data flow for describing a method for mixed reality content operation according to an exemplary embodiment.

FIG. 4 is an exemplary diagram for describing an application example of the apparatus for mixed reality content operation according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

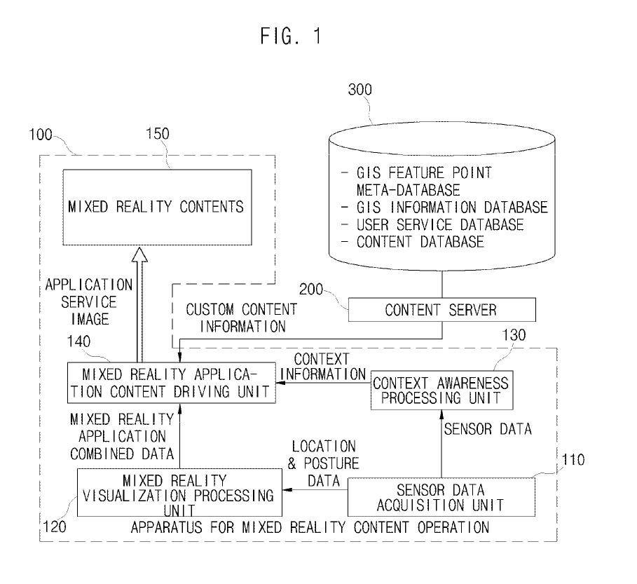

Hereinafter, an apparatus for mixed reality content operation according to an exemplary embodiment will be described with reference to FIG. 1. FIG. 1 is a block diagram illustrating an apparatus for mixed reality content operation according to an exemplary embodiment.

Referring to FIG. 1, an apparatus 100 for mixed reality content operation according to an exemplary embodiment is a mobile-based mixed reality content operating apparatus on which a camera is mounted, and includes a sensor data acquisition unit 110, a mixed reality visualization processing unit 120, a context awareness processing unit 130, a mixed reality application content driving unit 140, and a display unit 150.

The sensor data acquisition unit 110 extracts sensor information from a sensor network and a location/posture sensor.

The sensor data acquisition unit 110 acquires a raw sensor data from the location/posture sensor that is attached to a sensor network or a portable information terminal, processes the acquired data to output a location/posture data to the mixed reality visualization processing unit 130, and outputs all acquired sensor data to the context awareness processing unit 120.

That is, the sensor data acquisition unit 110 acquires data peripheral to a mobile device from a sensor network that is disposed at the periphery of a mobile device, and acquires the location/posture data of a camera from a location/posture sensor that tracks the location/posture of the camera. The sensor data acquisition unit 110 transfers the acquired location/posture data to the mixed reality visualization processing unit 120, and transfers the acquired peripheral data and location/posture data to the context awareness processing unit 130.

The mixed reality visualization processing unit 120 superposes a virtual object and a text on an actual image, which is acquired through a camera, to generate an image.

The mixed reality visualization processing unit 120 tracks a location/posture data in real time and performs image registration through image recognition based on a feature point to generate a combined image.

The context awareness processing unit 130 automatically analyzes the acquired sensor information or is aware of indoor/outdoor contexts from a location/posture sensor data.

In an embodiment, the context awareness processing unit 130 perceives contexts such as weather, location, time, a domain and a user's intention by using a sensor data to output the information of the perceived contexts to the mixed reality application content driving unit 140.

The mixed reality application content driving unit 140 provides content in a context linking type according to various mobile context awareness.

The mixed reality application content driving unit 140 provides content in which a custom data is reflected. The custom data is extracted by a content server 200 from an information/content database (DB) 300 in linkage with context information from the content server 200.

The display unit 150 displays content that is provided to a generated mixed reality image in a context linking type. For example, the display unit 150 provides mixed reality contents such as indoor and outdoor exhibition item guidance, personal navigation (for example, route guidance service) and individual custom advertisement.

The content server 200 links the information/content database 300 to context information and simultaneously extracts a content data linked to the context information from the information/content database 300, and outputs the extracted data to the mixed reality application content driving unit 140 through transmission over a wireless network.

The information/content database 300 includes a GIS feature point meta-database, a GIS information database (DB) and a content database. The information/content database 300 stores a user profile. The GIS feature point meta-database includes feature point metadata.

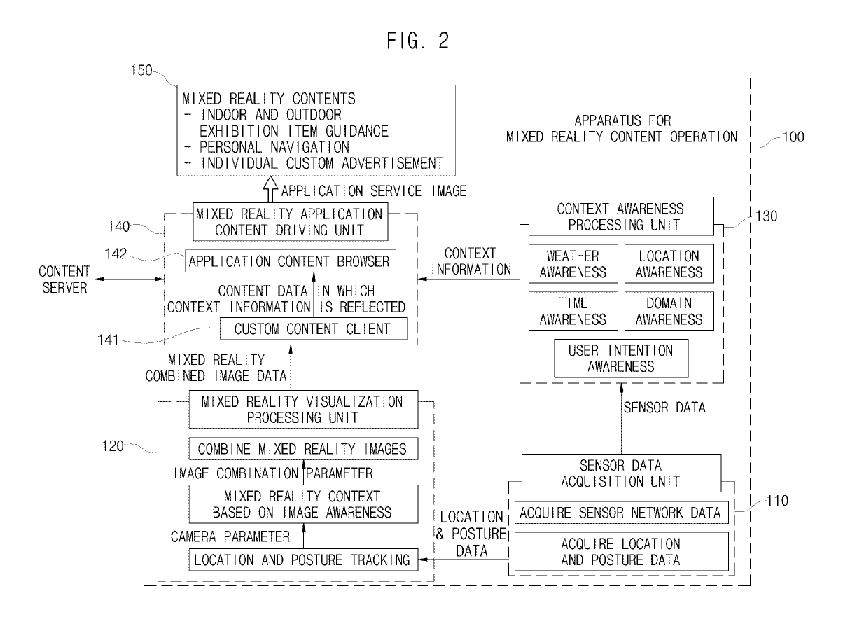

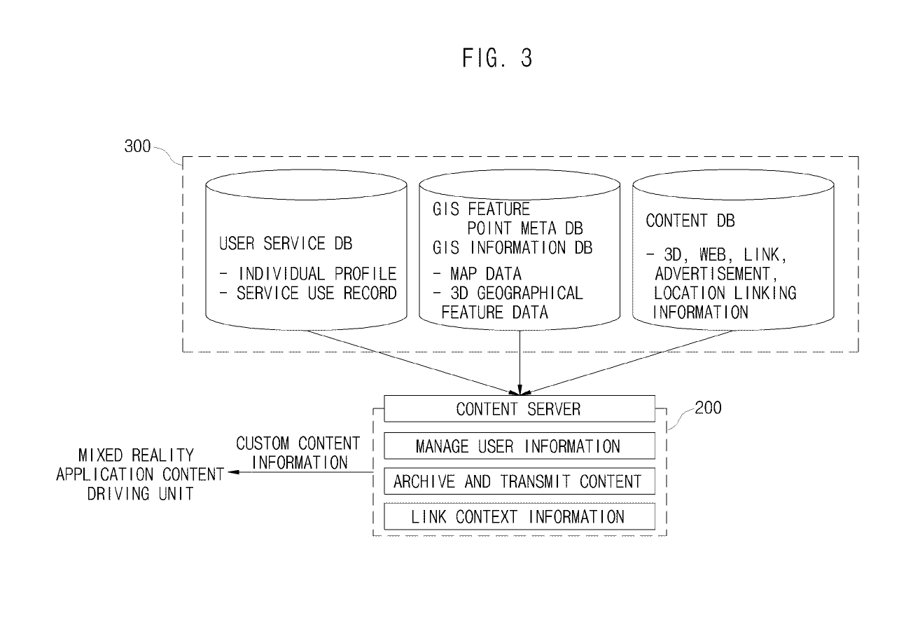

The apparatus for mixed reality content operation according to an exemplary embodiment has been described above with reference to FIG. 1. Hereinafter, a method for mixed reality content operation according to an exemplary embodiment will be described with reference to FIGS. 2 and 3. FIGS. 2 and 3 are diagrams illustrating data flow for describing a method for mixed reality content operation according to an exemplary embodiment.

Referring to FIGS. 2 and 3, the sensor data acquisition unit 110 acquires data peripheral to a mobile device from a sensor network, and acquires a location/posture data from a location/posture sensor. The sensor data acquisition unit 110 transfers the acquired location/posture data to the mixed reality visualization processing unit 120, and transfers all acquired sensor data, i.e., the peripheral data and the location/posture data to the context awareness processing unit 130.

The mixed reality visualization processing unit 120 includes a location and posture tracking module, a mixed reality matching module, and a mixed reality image combination module.

In an embodiment, the mixed reality visualization processing unit 120 tracks the location and posture of a camera through the location and posture tracking module, performs mixed reality matching based on image recognition from a camera parameter through the mixed reality matching module, and combines mixed reality images using an image combination parameter through the mixed reality image combination module.

In an embodiment, the context awareness processing unit 130 includes a weather awareness module, a location awareness module, a time awareness module, a domain awareness module and a user intention awareness module.

The context awareness processing unit 130 perceives current weather on the basis of a sensor data from the weather awareness module, a current location on the basis of a sensor data from the location awareness module, and a current time on the basis of a sensor data from the time awareness module. Moreover, the context awareness processing unit 130 perceives an information providing domain on the basis of a sensor data from the domain awareness module, and a user's intention on the basis of a sensor data from the user intention awareness module.

The mixed reality application content driving unit 140 includes a content client 141, and an application content browser 142. The mixed reality application content driving unit 140 may include an AMI (Automatic Meter Infrastructure) application content operation unit. The AMI application content operation unit may include an AMI application content driving software, and a user context awareness algorithm.

The content client 141 fetches a database data in accordance with context awareness from the content server 200.

The application content browser 142 graphically processes a mobile mixed reality content in which a content client and corresponding context information are reflected.

Herein, the mixed reality content is an application service image, and includes indoor and outdoor exhibition item guidance, personal navigation and individual custom advertisement.

The content server 200 manages user information, archives and transmits content, and is linked to context information. For example, the content server 200 extracts custom content information corresponding to context information from the information/content database 300, and transmits the extracted custom content information to the apparatus 100 for mixed reality content operation.

The information/content database 300 includes a user service database, a GIS feature point meta-database, a GIS information database, and a content database. The user service database stores user profiles and service use records. The GIS information database stores map data and Three-Dimensional (3D) geographical feature data. The content database stores 3D models, web links, advertisements, and location linking information. The GIS feature point meta-database stores more specific and detailed map-related data than the data stored in the GIS information database.

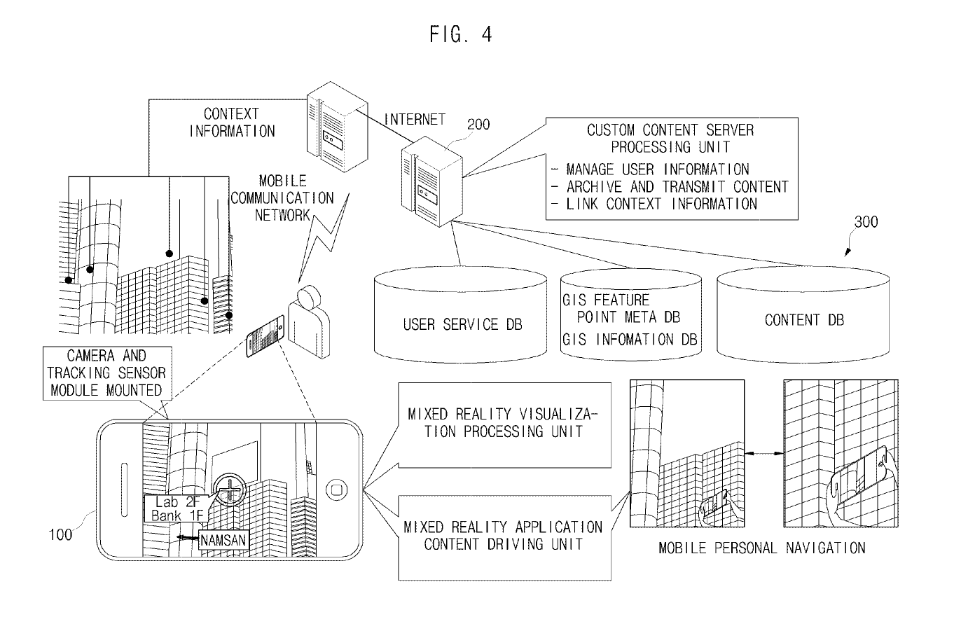

The data flow of the apparatus for mixed reality content operation according to an exemplary embodiment has been described above with reference to FIGS. 2 and 3. Hereinafter, an application example of the apparatus for mixed reality content operation according to an exemplary embodiment will be described with reference to FIG. 4. FIG. 4 is an exemplary diagram for describing an application example of the apparatus for mixed reality content operation according to an exemplary embodiment.

Referring to FIG. 4, the apparatus 100 for mixed reality content operation according to an exemplary embodiment may be mounted on mobile terminals.

When a user having a mobile terminal which mounts the apparatus 100 for mixed reality content operation is watching an exhibition or walking the street, the apparatus 100 for mixed reality content operation may receive an actual image through a camera mounted on the mobile terminal according to the manipulation of a user. The apparatus 100 for mixed reality content operation may provide service in which an additional description is represented as a mixed reality image having a type where a virtual object and a text are superposed on an object image such as a specific exhibition item or a building that is represented on an input actual image.

For example, when a user intends to watch an exhibition, the apparatus 100 for mixed reality content operation may serve as a virtual assistant to provide a guidance service to the user. When the user is moving, the apparatus 100 for mixed reality content operation may provide a building information guidance service, a building discrimination service and a route guidance service to the user.

For providing these services, the apparatus 100 for mixed reality content operation receives information corresponding to context information that is perceived by the content server 200.

That is, the content server 200 extracts information corresponding to context information that is perceived by the information/content database 300 including the user service database, the GIS information database, and the content database for providing information to the apparatus 100 for mixed reality content operation, and transmits the extracted information to the apparatus 100 for mixed reality content operation. The user service database stores user profiles and service use records. The GIS information database stores map data and 3D geographical feature data. The content database stores 3D models, web links, advertisements, and location linking information.

The apparatus 100 for mixed reality content operation may reflect detailed context information such as weather, location, time, a domain, and a user's intention to generate a mixed reality content image that is represented at a realistic level, thereby providing a mobile virtual advertisement service through the generated mixed reality content image.

Moreover, when a feature point meta-database is established for a building guidance information service, the apparatus 100 for mixed reality content operation may be provide service that enables to subdivide a complicated building that is related through the established feature point meta-database.

As described above, when the apparatus 100 for mixed reality content operation is mounted on a mobile terminal and operates an application content based on mixed reality, it may perceive a location by using the sensor information of a sensor network and camera image information, and moreover, may discriminate geographical and natural features by using various types of context awareness processing results such as weather, location, time, a domain and a user's intention and the feature point meta-database. Thus, the apparatus 100 for mixed reality content operation can provide an exhibition watch guidance service, a building guidance service, a route guidance service and a custom advertisement service, which are provided through auto context awareness in an indoor/outdoor environment, to a user in a mixed reality content type.

That is, the apparatus 100 for mixed reality content operation can overcome the limitations of service that receives an RFID-based mobile information service and a limited type of building guidance information in a mixed reality content type, thereby providing a new type of service.

Moreover, the apparatus 100 for mixed reality content operation may be applied to many fields such as a mobile virtual reality game service in which a plurality of users may participate in an entertainment field, ubiquitous computing, a pervasive intelligent application service, and work training and education or wearable computing in a virtual environment.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for mixed reality content operation based on a mobile device with a camera, the apparatus comprising:
a mixed reality visualization processing unit superposing at least one of a virtual object and a text on an actual image which is acquired through the camera to generate a mixed reality image;
a context awareness processing unit receiving at least one of sensed data peripheral to the mobile device and a location and posture data of the camera to perceive a peripheral context of the mobile device on the basis of the received data; and
a mixed reality application content driving unit adding a content in the mixed reality image to generate an application service image, the content being provided in a context linking type according to the peripheral context.

2. The apparatus of claim 1, further comprising a display unit which displays the application service image.

3. The apparatus of claim 1, further comprising a sensor data acquisition unit which acquires a peripheral data of the mobile device from a sensor network disposed at a periphery of the mobile device, and a location and posture data of the camera from a location and posture sensor which tracks a location and posture of the camera; and transfers the peripheral data to the context awareness processing unit and the location and posture data to the mixed reality visualization processing unit, respectively.

4. The apparatus of claim 3, wherein the mixed reality visualization unit generates the mixed reality image by tracking the location and posture data in real time and performing image registration through image recognition based on a feature point.

5. The apparatus of claim 3, wherein the context awareness processing unit perceives the peripheral context through perception of at least one of weather, location, time, a domain, and a user's intention by using at least one of the peripheral data and the location and posture data.

6. The apparatus of claim 1, wherein the mixed reality application content driving unit receives a custom data from a content server, the custom data being extracted on the basis of the peripheral context by the content server from a database connected to the content server and corresponding to the peripheral context.

7. The apparatus of claim 6, wherein the mixed reality application content driving unit receives a detailed information from the content server, the detailed information being extracted by the content server from a feature point meta-database established for information service and corresponding to the peripheral context.

8. The apparatus of claim 1, wherein:
the context awareness processing unit perceives the peripheral context through perception of at least one of weather, location, time, a domain, and a user's intention, and
the mixed reality application content driving unit provides at least one of an exhibition watch guidance service, a building guidance service, a route guidance service, and a custom advertisement service to a user in a mixed reality content type by using a feature point metadata corresponding to perception of the peripheral context.

9. A method for mixed reality content operation based on a mobile device with a camera, the method comprising:
receiving at least one of a peripheral data of the mobile device and a location and posture data of the camera;
superposing at least one of a virtual object and a text on an actual image which is acquired through the camera to generate a mixed reality image;
perceiving a peripheral context of the mobile device on the basis of the peripheral data and the location and posture data; and
adding a content in a context linking type according to the peripheral context in the mixed reality image to generate an application service image.

10. The method of claim 9, further comprising:
displaying the application service image on the screen of a display unit.

11. The method of claim 9, further comprising:
tracking the location and posture data in real time, and perceiving the actual image through image recognition based on a feature point; and
performing image registration based on the perceived actual image to generate the mixed reality image which is combined.

12. The method of claim 9, further comprising:
acquiring the peripheral data from a sensor network which is disposed at a periphery of the mobile device; and
acquiring the location and posture data from a location and posture sensor which tracks a location and posture of the camera.

13. The method of claim 9, wherein the perceiving of a peripheral context comprises perceiving the peripheral context through perception of at least one of weather, location, time, a domain and a user's intention by using at least one of the peripheral data and the location/posture data.

14. The method of claim 9, further comprising:
receiving a custom data from a content server, the custom data being extracted on the basis of the peripheral context by the content server from a database connected to the content server and corresponding to the peripheral context.

15. The method of claim 9, further comprising:
perceiving the peripheral context through perception of at least one of weather, location, time, a domain, and a user's intention, and
providing at least one of an exhibition watch guidance service, a building guidance service, a route guidance service, and a custom advertisement service to a user in a mixed reality content type by using a feature point metadata corresponding to perception of the peripheral context.
